(19) United States
(12) Patent Application Publication
(10) Pub. No.: US 2002/0182127 A1
(43) Pub. Date: Dec. 5, 2002

(54) Device and method for removing nitrogen oxides from the exhaust gas from lean-burn internal combustion engines

(76) Inventors: Tillmann Braun, Berglen (DE); Christian Kawetzki, Esslingen (DE); Klaus-Juergen Marquardt, Remshalden (DE); Ralf Moos, Bayrerth (DE); Ralf Mueller, Deggenhausertal (DE); Carsten Plog, Markdorf (DE); Rolf Schubert, Korntal (DE)

Correspondence Address: KENYON & KENYON, ONE BROADWAY, NEW YORK, NY, 10004, US

(21) Appl. No.: 10/157,718

(22) Filed: May 29, 2002

(30) Foreign Application Priority Data
May 31, 2001 (DE) 101 26 456.9

(51) Int. Cl. B01D 53/56; B01D 50/00; B01D 53/34; F01N 3/00; G05D 7/00

(52) U.S. Cl. 422/172; 423/235; 423/239.1; 422/168; 422/169; 422/170; 422/177; 422/105

(57) ABSTRACT

A device and method for removing nitrogen oxides from the exhaust gas from lean-burn internal combustion engines, e.g., diesel engines used in motor vehicles, includes a feed for a reducing agent, an NH₃ sensor for measuring the NH₃ concentration in the exhaust gas, and an exhaust pipe with NOx reduction catalytic converter. The arrangement configured to feed in reducing agent includes a control circuit for quantitatively continuously controllable supply of reducing agent to the exhaust gas, the control variable of the control circuit being the NH₃ concentration measured by the NH₃ sensor, and the guide variable of the control circuit being an NH₃ concentration value which may be predetermined as a function of the operating point of the internal combustion engine. The NOx reduction catalytic converter is divided into at least two parts which are separate from one another and are arranged in series in the direction of flow of the exhaust gas. For the method, the control variable used may be the NH₃ concentration measured by the NH₃ sensor, and the guide variable used may be an NH₃ concentration value which may be predetermined as a function of the operating point of the internal combustion engine.

### FIELD OF THE INVENTION

The present invention relates to a device and method for removing nitrogen oxides from the exhaust gas from lean-burn internal combustion engines.

### BACKGROUND INFORMATION

German Published Patent Application No. 42 17 552 describes an exhaust-gas aftertreatment device for motor vehicle diesel engines, having an NOx reduction catalytic converter and an NH₃ metering device, in which the supply of NH₃ is switched on and off according to a predeterminable lower and upper NH₃ threshold concentration in the exhaust gas. A sensor which measures the NH₃ concentration in the gas phase and a further sensor, which measures the NH₃ adsorbed in the NOx reduction catalytic converter, are provided for the purpose of determining the threshold concentrations.

At NOx reduction catalytic converters, NOx is reduced to harmless nitrogen (N₂) by a reducing agent. Under the oxidizing conditions in the exhaust gas from a lean-burn internal combustion engine, such as for example a diesel engine, this requires a selective reduction reaction to take place between NOx and the reducing agent, so that the reducing agent does not undesirably react with the oxygen, of which there is a high excess in the exhaust gas. The NOx reduction catalytic converters used are primarily what are known as SCR (SCR=selective catalytic reduction) catalytic converters, at which NOx is reduced to harmless N₂ under oxidizing conditions in a selective reduction reaction with the reducing agent NH₃. The reducing agent is usually added to the exhaust gas from the outside. Suitable reducing agents are NH₃ or a substance which releases NH₃ in the exhaust gas, such as for example urea.

Conventional SCR catalytic converters must have stored a sufficient quantity of NH₃ to allow a certain conversion of NOx to be achieved. The quantity of NH₃ which can be stored is very greatly dependent on the temperature and the flow rate of the exhaust gas or the exhaust-gas mass flow. Specifically, the quantity of NH₃ which can be stored in the NOx reduction catalytic converter decreases greatly as the temperature rises and the exhaust-gas throughput increases. If a high conversion of NOx is desired, the SCR catalytic converter should have stored as high a quantity of NH₃ as possible. However, if the stored quantity of NH₃ exceeds a certain level, the NOx conversion is accompanied by a certain NH₃ discharge (NH₃ slippage) from the catalytic converter. On account of the harmful properties and pungent odor of NH₃, this NH₃ slippage is undesirable and should be limited to, for example, 10 ppm. The quantity of NH₃ which can be stored in the catalytic converter without slippage or for a predetermined level of slippage is accordingly limited and is dependent primarily on the exhaust-gas temperature, or the catalytic converter temperature, the exhaust-gas mass flow and the supply of NOx. If the catalytic converter temperature and/or the exhaust-gas mass flow suddenly increases, standard SCR catalytic converters undesirably release NH₃ as a result of desorption. For this reason, the quantity of NH₃ which is stored in the SCR catalytic converter is usually kept at a lower level than that required for optimum conversion of NOx.

### SUMMARY

It is an object of the invention to provide a device and a method which have an improved effectiveness with regard to the selective reduction of the levels of nitrogen oxides (NOx) combined, at the same time, with a reduced level of NH₃ slippage.

In the device according to the present invention, the reducing agent is fed into the exhaust gas from the internal combustion engine in a metered fashion by a control circuit for quantitatively continuously controllable supply of reducing agent. The reducing agent used may be NH₃ or a substance which releases NH₃. In the context of the present invention, the term quantitatively continuous control is to be understood as meaning that the guide variable, unlike an on/off control or a two-point control, may adopt a multiplicity of different values, for example a continuum of values within a defined range. The control circuit is constructed so that the control variable used is the NH₃ concentration measured by an NH₃ sensor in the exhaust gas, and as the guide variable it is possible to predetermine an NH₃ concentration value, which is dependent on the operating state of the internal combustion engine. This guide variable which may be predetermined as a function of the operating point makes it possible to react flexibly to changing operating states of the internal combustion engine and to optimize the quantity of NH₃ stored in the catalytic converter for a high conversion of NOx. The operating point of the internal combustion engine is in this case determined, for example, by torque and rotational speed or by other characteristic variables, such as the concentration of the NOx emission from the internal combustion engine in the exhaust gas, the exhaust-gas temperature and the exhaust-gas mass flow. Any structure may be suitable for the control circuit.

According to the present invention, the NOx reduction catalytic converter has at least two parts which are separate from one another and are arranged in series in the direction of flow of the exhaust gas. The NOx reduction catalytic converter is configured as a standard SCR catalytic converter. If the catalytic converter is divided, it is possible, for example, for the first part of the catalytic converter to be provided with a high NH₃ loading, and consequently it is also possible for a high NOx conversion to be achieved at this catalytic-converter part. The relatively high NH₃ slippage which necessarily occurs in this case may be taken up by the following catalytic-converter part. NOx which has not been converted at the first catalytic-converter part may then be completely or predominantly converted at the second catalytic-converter part by the NH₃ slippage from the first catalytic-converter part. The volume of the individual catalytic-converter parts may be adapted to the NH₃ storage properties and the range of dynamics of the internal combustion engine. A volumetric ratio of the catalytic-converter parts may be in the range from 1:10 to 10:1.

In an example embodiment of the present invention, the supply of reducing agent to the exhaust gas from the internal combustion engine occurs on the inlet side of the first part of the NOx reduction catalytic converter, in the direction of flow, and the NH₃ sensor for determining or measuring the NH₃ concentration in the exhaust gas is arranged on the outlet side of each part of the NOx reduction catalytic converter. Fitting the NH₃ sensors on the outlet side of the individual catalytic-converter parts allows the possibility of determining the NH₃ slippage of the entire catalytic converter in a positionally-resolved manner, so that the state of the catalytic converter, and in particular the NH₃ loading of the catalytic converter, may be recorded more successfully. Therefore, the NH₃ loading of the catalytic converter overall may be increased up to the limit of the NH₃ loading which may still be implemented without slippage for maximum NOx conversion, and therefore the NOx conversion may be increased to the maximum value. Particularly when the catalytic converter is divided into a plurality of parts, it is possible for the catalytic-converter performance to be recorded differentially. By contrast, in the case of an undivided catalytic converter of the same overall volume and NH₃ measurement, the integral catalytic-converter performance may only be recorded on the outlet side of the catalytic converter.

In another example embodiment of the present invention, the addition of reducing agent takes place on the inlet side of each catalytic-converter part, and the NH₃ sensor for determining or measuring the NH₃ concentration in the exhaust gas is arranged on the outlet side of the last part of the NOx reduction catalytic converter, in the direction of flow. The possibility of supplying the reducing agent at various locations of the overall catalytic converter means that the NH₃ loading profile which is present in the catalytic converter in the direction of flow may be influenced. One or more NH₃ sensors may be saved.

In the method according to the present invention, the supply of reducing agent to the exhaust gas from the internal combustion engine occurs in a quantitatively continuously controllable manner by a control circuit, the control variable used being the NH₃ concentration measured by the NH₃ sensor, and the guide variable used being an NH₃ concentration value which may be predetermined as a function of the operating point of the internal combustion engine. It may, of course, be necessary for the NH₃ concentration measured value which is used as a control variable to be converted into a signal value which may be processed practically, for example in the control unit of the control circuit. The quantitatively continuous control of the supply of reducing agent may achieve an advantage over discontinuous on/off-controlled addition of reducing agent or over addition of reducing agent which is controlled on the basis of characteristic diagrams, as tests have shown. It is possible to work with a larger quantity of NH₃ stored in the SCR catalytic converter and therefore with a higher NOx conversion, without there being an unacceptably high NH₃ slippage. In combination with the inventive splitting of the catalytic converter, it is possible to avoid in particular the NH₃ slippage which is possible in the event of a sudden load change of the internal combustion engine.

In another example embodiment of the present invention, the NH₃ concentration in the exhaust gas is measured on the outlet side of each catalytic-converter part, by an NH₃ sensor arranged at those locations, and the reducing agent is supplied on the inlet side of the first catalytic-converter part, in the direction of flow.

In another example embodiment of the present invention, the NH₃ sensor, which has an NH₃ concentration measured value, is used as control variable for the continuous control of the supply of reducing agent is selected as a function of the operating point of the internal combustion engine, and in a further example embodiment of the present invention is selected as a function of the NH₃ concentration values measured on the outlet side of each part of the NOx reduction catalytic converter. This in particular avoids having to set an NH₃ concentration value of zero, which experience has shown entails considerable control difficulties. This is because if an NH₃ sensor measures an NH₃ slippage of zero, this means that, beyond a certain distance upstream of the sensor, the NH₃ loading in the catalytic converter is small or even non-existent. Therefore, this catalytic-converter part is also not being used for NOx conversion, and consequently potential for reducing NOx is lost. Therefore, if the NH₃ sensor the measured value of which is used as control variable measures a very low NH₃ concentration or an NH₃ concentration of zero, the measured value from the NH₃ sensor which is arranged on the outlet side of the catalytic-converter part which is arranged further upstream is used as control variable for the continuously controlled supply of NH₃. This NH₃ concentration value is not zero, on account of the NH₃ loading increasing towards the catalytic-converter inlet side, and may therefore be used as a control variable. Conversely, operation switches to an NH₃ sensor arranged further downstream if a high NH₃ slippage is measured.

In a further example embodiment of the present invention, an NH₃ sensor for measuring the NH₃ concentration in the exhaust gas is accommodated on the outlet side of the last part of the NOx reduction catalytic converter, in the direction of flow, and the supply of reducing agent to the exhaust gas from the internal combustion engine occurs on the inlet side of each part of the NOx reduction catalytic converter. In particular, in a further example embodiment of the present invention, that part of the NOx reduction catalytic converter on the inlet side of which the supply of reducing agent occurs is selected as a function of the operating point of the internal combustion engine. This operating point may be provided by its position in the torque/rotational speed characteristic diagram or by variables such as the concentration of the NOx emissions from the internal combustion engine in the exhaust gas, the exhaust-gas temperature and the exhaust-gas mass flow. As a result, it is likewise possible for the entire catalytic-converter volume to be used for NH₃ storage. Furthermore, the variable location at which the reducing agent is supplied indicates that there is generally a low but measurable NH₃ slippage at the outlet of the last catalytic-converter part, and therefore the NH₃ sensor fitted there supplies a measured value which is not equal to zero. Therefore, this measured value may be used as a control variable for the supply of reducing agent.

In the device according to another example embodiment of the present invention, at least two NH₃ sensors are arranged in the NOx reduction catalytic converter, which is of single-part configuration, and the reducing agent is fed into the exhaust gas from the internal combustion engine in metered fashion by a control circuit for quantitatively continuously controllable supply of reducing agent, and the supply of reducing agent occurs on the inlet side of the NOx reduction catalytic converter. The guide variable of the control arrangement is predetermined as a function of the operating point. The control variable used is the measured value supplied by one of the NH₃ sensors. Fitting two or more NH₃ sensors in the catalytic converter allows well-resolved determination of the NH₃ concentration gradient which is present in the SCR catalytic converter. Therefore, the behavior of the control section, the essential component of which is the SCR catalytic converter, may be described more successfully and the control arrangement may be optimized. Furthermore, a more compact structure may be achieved by dispensing with the need to separate the catalytic converter into two or more parts.

In a further example embodiment of the present invention, the NH₃ sensors are integrated in the catalytic converter. The catalytic converter, which may be configured as a honeycomb body, may, for example, have sensitively active areas in some passages, or the NH₃ sensors may be part of the catalytically active coating, with the result that the NH₃ concentration measured values, which may be of importance, may be determined more accurately.

In this case too, in a further example embodiment of the present invention, one of the NH₃ sensors the NH₃ concentration measured value of which is used as control variable is selected as a function of the operating point of the internal combustion engine or as a function of the respective NOx concentration measured values.

There are various possible manners of configuring and developing the present invention. Specific exemplary embodiments of the present invention are illustrated schematically in the Figures and are explained in more detail in the following description.

### BRIEF DESCRIPTION OF THE DRAWINGS

FIG. 1 is a schematic block diagram of a control circuit for quantitatively continuously controllable supply of reducing agent.

FIG. 2 is a schematic block diagram of an internal combustion engine with associated exhaust-gas cleaning installation, with a catalytic converter which is divided into two parts in the exhaust pipe.

FIG. 3 is a further schematic block diagram of an internal combustion engine with associated exhaust-gas cleaning installation with a catalytic converter which is divided into two parts in the exhaust pipe.

FIG. 4 is a further schematic block diagram of an internal combustion engine with associated exhaust-gas cleaning installation with an undivided catalytic converter in the exhaust pipe.

### DETAILED DESCRIPTION

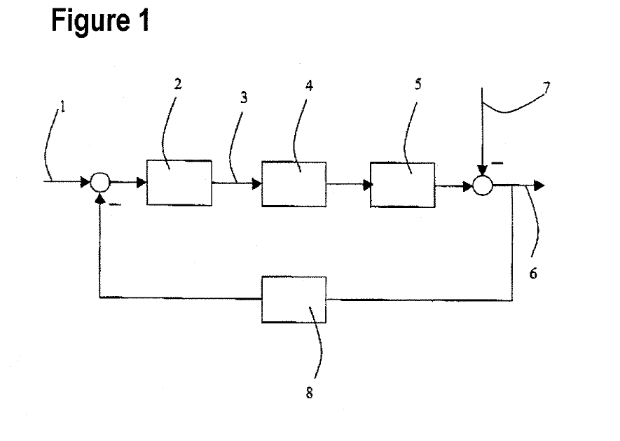

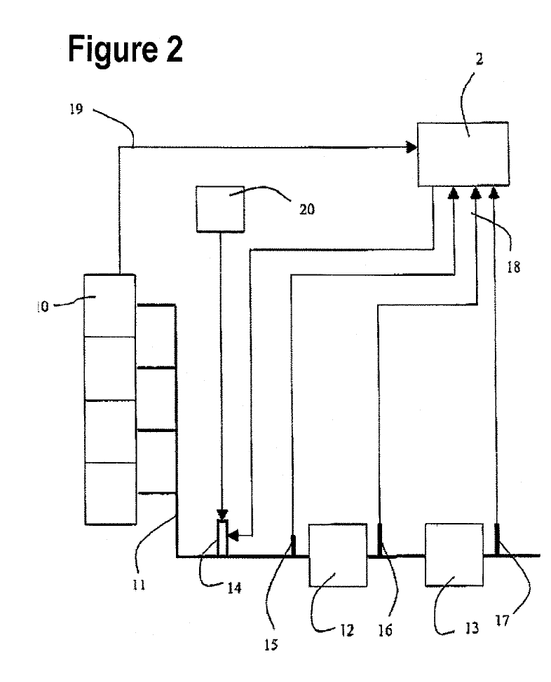

The control circuit which is schematically illustrated in FIG. 1 is used for continuously controlled supply of reducing agent to the exhaust gas from an internal combustion engine 10 illustrated in FIG. 2. A guide variable 1 of the control circuit is an electrical signal which is derived, e.g., through a proportional relationship, from a predeterminable NH₃ concentration value. The guide variable 1 represents the desired value for the NH₃ concentration, which is returned in the control circuit as control variable 6 after measurement by the measuring device 8. The measuring device 8 is in this case represented by an NH₃ sensor. Any conversion which may be required for the signal supplied by the NH₃ sensor is performed by a separate measurement converter or in a control unit 2. The resulting signal therefore represents the actual value of the NH₃ concentration at that location in the exhaust gas at which the NH₃ sensor is accommodated. The desired value and actual value of the NH₃ concentration are linked by subtraction, and the resulting value is fed to the control unit 2 as control deviation. With the aid of the functionality implemented in the control unit 2, a setting variable 3 is generated as control signal which acts on an actuator 4. The setting variable 3 is a signal which, for example, is proportionally related to the quantitative flow of reducing agent which is to be added to the exhaust gas. The actuator 4 influences the supply of reducing agent into the exhaust gas in the desired manner. The actuator 4 is configured, for example, as a metering valve, the opening time or opening width of which is influenced by the setting variable 3 in such a manner that the supply of reducing agent to the exhaust gas is implemented at the predetermined level. As a result, the state of an overall control section 5 is influenced in the intended manner. The control section 5 is substantially formed by the SCR catalytic converter and is predominantly characterized by the NOx reduction behavior, the stored NH₃ quantity and the NH₃ slippage of this catalytic converter. The influence of interfering variables 7 which act on the entire control section 5 is taken into account, for example by linking by subtraction to the output variable from the control section 5. It may be important to be possible to predetermine the value of the guide variable 1 as a function of the operating point of the internal combustion engine 10. The operating point of the internal combustion engine 10 is given, for example, by its position in the torque/rotational speed characteristic diagram. From this it is possible, in an electronic engine management system for controlling the internal combustion engine 10, for example using further characteristic diagrams, to derive the NOx emission, the exhaust-gas temperature and further variables which may be used to form the predeterminable guide variable 1.

The schematic illustration of the control circuit which is illustrated in FIG. 1 is used as an abstract representation and is therefore not to be understood as a precise image of the manner in which all the system components are physically linked to one another. In particular, it is possible, for example, for the control device 2 to have further signal inputs of further system components, or further functionalities, such as signal amplifiers, signal transformers or switching contacts, which, however, are of subordinate importance with regard to the actual fact of continuously controlled supply of reducing agent.

The control circuit which is illustrated schematically in FIG. 1 may be produced with a different structure by taking various formal measures. For example, it is possible for the function of the actuator 4 to be incorporated in the control section 5 or for the function of the measuring device 8 to be incorporated in the control device 2, thus eliminating the corresponding structural blocks. Furthermore, it is also possible to take control measures allowing the structure of the control circuit to be changed. For example, interfering variables may be taken account of by a control measure, with the result that the structure of the control circuit and the control operation are changed accordingly.

FIG. 2 illustrates, by way of example, a schematic block diagram of an internal combustion engine 10 with associated exhaust-gas cleaning installation. The exhaust gas which is expelled from the internal combustion engine 10 is taken into an exhaust pipe 11 and successively flows through the two catalytic-converter parts 12 and 13, which are arranged in series. On the inlet side of the first catalytic-converter part 12 there is a temperature sensor 15 for measuring the exhaust-gas temperature in the exhaust pipe 11, and further upstream of the temperature sensor 15 a metering valve 14 is introduced for adding reducing agent to the exhaust gas. The metering valve 14 is supplied with reducing agent from a vessel 20. There are NH₃ sensors 16 and 17 in the exhaust pipe 11 on the outlet side of each of the catalytic-converter parts 12 and 13, respectively. These NH₃ sensors 16 and 17 are used to measure the NH₃ slippage from the respective catalytic-converter parts 12 and 13. The NH₃ sensors 16, 17, the temperature sensor 15 and the metering valve 14 are connected to the control device 2 by signal lines 18. Furthermore, the control device 2 is connected to the internal combustion engine 10 via a further signal line 19. Via this signal line 19, the control device 2 receives information about important operating-state variables of the internal combustion engine 10. This may, for example, be information about the torque provided or the rotational speed. It is also possible for further calculated variables or variables stored in characteristic diagrams, such as for example the NOx emission or the exhaust-gas temperature, to be transmitted from the electronic control unit of the internal combustion engine 10, via the abovementioned signal line 19, to the control device 2.

Further components, which are of no fundamental importance to the continuously controlled addition of reducing agent, may be included in the exhaust pipe 11. For example, there may be an additional oxidation catalytic converter or a particle filter fitted in the exhaust pipe 11, downstream or upstream of the catalytic-converter parts 12 and 13 which are shown. Furthermore, further sensors, such as for example an NOx sensor or temperature sensors, may be accommodated in the exhaust pipe 11 and may be connected to the control device 2 in order to improve the control performance.

The metering of reducing agent occurs, for example, so that, within a defined characteristic-diagram area of the internal combustion engine 10, the measured value from the NH₃ sensor 16 arranged downstream of the first catalytic-converter part 12 is used by the control device 2 as control variable 6. This characteristic-diagram area is, for example, characterized in that the area includes the power range with a power of lower than half the rated power of the internal combustion engine. As guide variable 1, the control device 2 is supplied, for example, with an NH₃ concentration value of 10 ppm, and the addition of reducing agent is controlled by the control device 2 so that this NH₃ concentration value is established at the outlet of the catalytic-converter part 12. As a result of this measure, under the described operating conditions of the internal combustion engine 10, the catalytic-converter part 13 which is arranged downstream of the catalytic-converter part 12 has only a small quantity of stored NH₃ and accordingly has a relatively high capacity to take up NH₃. If a sudden load increase now takes place at the internal combustion engine 10, the exhaust-gas temperature and the exhaust-gas throughput are suddenly increased as a result. Consequently, a large quantity of NH₃ is released by the catalytic-converter part 12. However, this suddenly increased NH₃ slippage from the catalytic-converter part 12 cannot break through the catalytic-converter arrangement, since it is taken up by the downstream catalytic-converter part 13. Therefore, in this manner, when the power output from the internal combustion engine 10 rises suddenly, an undesirable release of NH₃ into the atmosphere is avoided. After the sudden load change, the control device 2 attempts to compensate for the effects of the interfering variable 7 which has become active (the sudden change in load), and therefore the quantity of reducing agent supplied is reduced.

In the characteristic-diagram area which is characterized by a power which is greater than half the rated power of the internal combustion engine, in the example under consideration the signal from the NH₃ sensor 17 is used as control variable by the control device 2. Since a further very considerable increase in output from the internal combustion engine 10 may now not occur, operation is switched to a relatively high, but still tolerable NH₃ concentration value of, for example, 10 ppm as guide variable 1. This also results in a high conversion of NOx, since the NOx conversion is directly linked to the NH₃ slippage, and the entire volume of the catalytic converter is used to reduce the levels of NOx.

If the signal from the NH₃ sensor 17 is used as control variable 6 by the control device 2 and if there is no NH₃ slippage on the outlet side of the catalytic-converter part 13, a control difficulty occurs since it is necessary to control at an NH₃ concentration value of zero. This problem is countered by the fact that, in this case, operation switches to the NH₃ sensor 16 as source for the control variable 6. Since the NH₃ sensor 16 records the NH₃ slippage of a catalytic-converter part 12 which is arranged further upstream, in this case an NH₃ slippage of greater than zero is measured, and control may continue without problems. Conversely, if there is a high measured NH₃ slippage, for example from the NH₃ sensor 16, operation switches to the NH₃ sensor 17 which is arranged further downstream as source of the control variable 6.

Further improved matching of the control behavior to the NH₃ storage behaviour and NH₃ slippage behavior of the catalytic-converter parts 12, 13 is achieved by the NH₃ concentration value used as guide variable 1 being predetermined as a function of the operating point of the internal combustion engine 10. Variables which characterize the operating point which are used in this case are the exhaust-gas temperature, the exhaust-gas mass flow rate, the NOx emissions from the internal combustion engine 10 or the torque and rotational speed of the internal combustion engine 10.

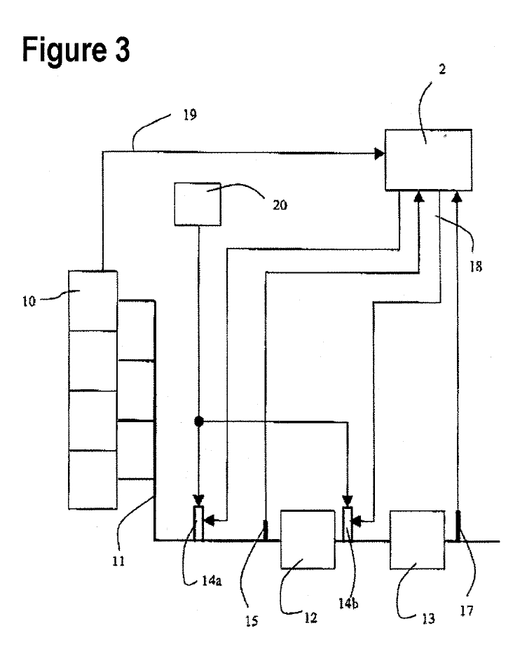

FIG. 3 illustrates a block diagram of a further example embodiment of the schematic structure of a device for removing nitrogen oxide from the exhaust gas from an internal combustion engine 10. Significant parts of this block diagram correspond to the block diagram illustrated in FIG. 2. Therefore, in FIG. 3, the corresponding components and components which have the same function are provided with the same reference numerals as those used in FIG. 2. Unlike the arrangement illustrated in FIG. 2, there is a reducing-agent metering valve 14a and 14b on the inlet side of each of the catalytic-converter parts 12 and 13, respectively. However, the device illustrated in FIG. 3 includes only one NH₃ sensor 17 in the exhaust pipe 11, on the outlet side of the catalytic-converter part 13.

Very good NOx conversion combined, at the same time, with a low NH₃ slippage is achieved in the arrangement illustrated in FIG. 3 by the following operating method. The control variable 6 used is the measured value which is supplied by the NH₃ sensor 17, and the supply of NH₃ to the exhaust gas takes place as a function of the operating point of the internal combustion engine 10, either through activation of the metering valve 14a or through activation of the metering valve 14b. The dependency on the operating point of the internal combustion engine 10 may be configured so that, in a lower power range of the internal combustion engine 10, the addition of reducing agent is carried out only on the inlet side of the second catalytic-converter part 13 by the metering valve 14b. In the other, upper power range of the internal combustion engine 10, the addition of reducing agent is taken over by the metering valve 14a on the inlet side of the first catalytic-converter part 12. The transition between the two abovementioned power ranges is defined, for example, by the value of half the rated power of the internal combustion engine 10. This selection of the location at which the reducing agent is supplied as a function of the operating point likewise very effectively prevents NH₃ from being released into the atmosphere in the event of a sudden load change in the internal combustion engine 10. In this example embodiment, an NH₃ sensor is saved compared to the device illustrated in FIG. 2. If the SCR catalytic converter is divided into more than two parts, a correspondingly greater number of NH₃ sensors are saved, since in this case too only one NH₃ sensor is provided, on the outlet side of the last catalytic-converter part 13, in the direction of flow of the exhaust gas. In this example, there is, at the same time, increased flexibility with regard to the location at which the reducing agent is added, since a reducing-agent metering valve is used on the inlet side of each catalytic-converter part. This allows assignment of different characteristic-diagram areas to reducing-agent addition points, with the result that the NH₃ storage behavior and the NH₃ slippage behavior of the SCR catalytic converter may be particularly well matched to the dynamic operation of the internal combustion engine.

Increased flexibility and an improved NOx conversion performance are also achieved by the fact that the NH₃ concentration value used as guide variable 1 is predetermined as a function of the operating point of the internal combustion engine 10 or the volumetric ratio of the catalytic-converter parts 12, 13 is selected in a suitable way.

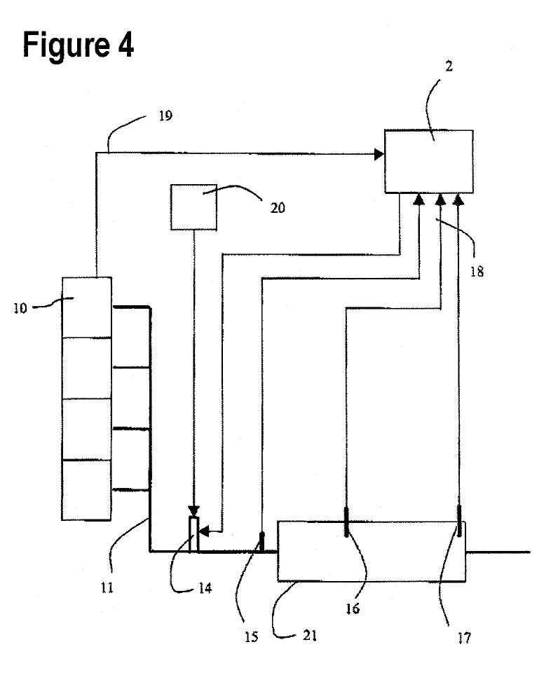

FIG. 4 is a block diagram of a further example embodiment for the schematic structure of a device for removing nitrogen oxides from the exhaust gas from an internal combustion engine 10. In FIG. 4, identical reference numerals to those used in FIGS. 2 and 3 correspond to identical components, so that there is no need for the function of the components which have already been mentioned to be explained in connection with the present example embodiment.

In this example embodiment, the SCR catalytic converter 21 is of single-piece configuration and includes two NH₃ sensors 16 and 17. For accuracy of control, the NH₃ sensors 16, 17 may be integrated in the catalytic-converter body or even in the catalytic coating of the SCR catalytic converter 21. The location in the catalytic converter 21 at which the NH₃ sensors 16, 17 are introduced is selected according to the catalytic-converter properties. The NH₃ sensor 17 may be located in the vicinity of the outlet side of the catalytic converter 21, in order for sensor 17 to be possible for the NH₃ slippage from the catalytic converter 21, which may be of importance in connection with the release of NH₃ into the atmosphere, to be measured at that location. To further optimize the NOx conversion combined, at the same time, with a low NH₃ slippage, the NH₃ sensor 16 or 17 the signal of which is used as control variable for the supply of reducing agent is selected as a function of the operating point of the internal combustion engine 10 or as a function of the NH₃ concentration measured values from the NH₃ sensors 16, 17. Moreover, in this case the NH₃ concentration value used as guide variable 1 is predetermined as a function of the operating point of the internal combustion engine 10.

What is claimed is:

1. A device for removing nitrogen oxides from exhaust gas from a lean-burn internal combustion engine, comprising:
an arrangement configured to feed a reducing agent into the exhaust gas;
an NH₃ sensor configured to determine a NH₃ concentration in the exhaust gas;
an exhaust pipe including an NOx reduction catalytic converter; and
a control circuit configured to feed the reducing agent into the exhaust gas in metered fashion in accordance with quantitative continuously controlled supply of the reducing agent, the control circuit including a control variable and a guide variable, the control variable including the NH₃ concentration determined by the NH₃ sensor, the guide variable including an NH₃ concentration value predetermined as a function of an operating point of the internal combustion engine;
wherein the NOx reduction catalytic converter is divided into at least two parts separate from one another and arranged in series in a direction of flow of the exhaust gas.

2. The device according to claim 1, wherein the internal combustion engine includes a diesel engine of a motor vehicle.

3. The device according to claim 1, wherein the supply of reducing agent to the exhaust gas from the internal combustion engine is configured to occur on an inlet side of a first part of the NOx reduction catalytic converter, the NH₃ sensor arranged in the exhaust gas on an outlet side of each of the parts of the NOx reduction catalytic converter.

4. The device according to claim 1, wherein the supply of reducing agent to the exhaust gas from the internal combustion engine is configured to occur on an inlet side of each of the parts of the NOx reduction catalytic converter, the NH₃ sensor arranged in the exhaust gas on an outlet side of a last part of the NOx reduction catalytic converter.

5. A method for removing nitrogen oxides from an exhaust gas from a lean-burn internal combustion engine including an arrangement configured to feed a reducing agent into the exhaust gas, an NH₃ sensor configured to determine an NH₃ concentration in the exhaust gas and an exhaust pipe including an NOx reduction catalytic converter, comprising the steps of:
dividing the NOx reduction catalytic converter into at least two parts separate from one another and arranged in series in a direction of flow of the exhaust gas; and
controlling a supply of reducing agent to the exhaust gas from the internal combustion engine in a quantitatively continuously controllable manner by a control circuit, the NH₃ concentration determined by the NH₃ sensor corresponding to a control variable of the control circuit, an NH₃ concentration value predetermined as a function of an operating point of the internal combustion engine corresponding to a guide variable of the control circuit.

6. The method according to claim 5, wherein the internal combustion engine includes a diesel engine of a motor vehicle.

7. The method according to claim 5, further comprising the steps of:
supplying the reducing agent to the exhaust gas from the internal combustion engine on an inlet side of a first part of the NOx reduction catalytic converter; and
determining the NH₃ concentration in the exhaust gas by a respective NH₃ sensor arranged on an outlet side of each of the two parts of the NOx reduction catalytic converter.

8. The method according to claim 7, further comprising the step of selecting an NH₃ sensor the NH₃ concentration value of which corresponds to the control variable as a function of the operating point of the internal combustion engine.

9. The method according to claim 7, further comprising the step of selecting the NH₃ sensor the NH₃ concentration value of which corresponds to the control variable as a function of NH₃ concentration values determined on an outlet side of each of the two parts of the NOx reduction catalytic converter.

10. The method according to claim 5, further comprising the steps of:
supplying the reducing agent to the exhaust gas from the internal combustion engine on an inlet side of each of the parts of the NOx reduction catalytic converter; and
determining the NH₃ concentration on an outlet side of a last part of the NOx reduction catalytic converter.

11. The method according to claim 10, wherein the control variable includes the NH₃ concentration determined by the NH₃ sensor arranged in the outlet side of the last part of the NOx reduction catalytic converter in a direction of flow of the exhaust gas, the method further comprising the step of selecting the NOx reduction catalytic converter part having an inlet side used for the supply of the reducing agent as a function of the operating point of the internal combustion engine.

12. A device for removing nitrogen oxides from an exhaust gas from a lean-burn internal combustion engine, comprising:
an arrangement configured to feed a reducing agent into the exhaust gas;
a first NH₃ sensor configured to determine an NH₃ concentration in the exhaust gas;
an exhaust pipe including an NOx reduction catalytic converter, the catalytic converter configured as a single part, at least two second NH₃ sensors arranged in the NOx reduction catalytic converter;
a control circuit configured to feed the reducing agent into the exhaust gas in metered fashion by in accordance with a quantitatively continuously controlled supply of the reducing agent, the control circuit including a control variable and a guide variable, the control variable including the NH₃ concentration determined by one of the second NH₃ sensors, the guide variable including an NH₃ concentration value predetermined as a function of an operating point of the internal combustion engine;
wherein the supply of reducing agent is configured to occur on an inlet side of the NOx reduction catalytic converter.

13. The device according to claim 12, wherein the internal combustion engine includes a diesel engine of a motor vehicle.

14. The device according to claim 12, wherein the second NH₃ sensors are integrated in the NOx reduction catalytic converter.

15. The device according to claim 12, wherein the second NH₃ sensor the NH₃ concentration value of which corresponds to the control variable is selectable as a function of the operating point of the internal combustion engine.

16. The device according to claim 12, wherein the second NH₃ sensor the NH₃ concentration value of which corresponds to the control variable is selectable as a function of the NH₃ concentration value determined on an outlet side of each part of the NOx reduction catalytic converter.
